(19) United States
(12) Patent Application Publication
(10) Pub. No.: US 2009/0226820 A1
(43) Pub. Date: Sep. 10, 2009

(54) Nonaqueous Electrolyte for Battery

(75) Inventors: Jong Ho Jeon, Guri-si (KR); Ho Seok Yang, Daejeon-si (KR); Jung Kang Oh, Incheon-si (KR); Hak Soo Kim, Daegu-si (KR); Jong Seob Kim, Daejeon-si (KR)

Correspondence Address: SUMMA, ADDITON & ASHE, P.A., 11610 NORTH COMMUNITY HOUSE ROAD, SUITE 200, CHARLOTTE, NC, 28277, US

(73) Assignee: CHEIL INDUSTRIES, INC., (KR)

(21) Appl. No.: 11/718,031

(22) PCT Filed: Oct. 27, 2004
(86) PCT No.: PCT/KR04/02728

§ 371 Date: Apr. 26, 2007

(51) Int. Cl. H01M 6/16

(52) U.S. Cl. 429/334; 429/337

(57) ABSTRACT

The present invention relates to a nonaqueous electrolyte for a battery, and more particularly to a novel nonaqueous electrolyte for a battery in which a furanone based derivative is added to a conventional nonaqueous electrolyte for the lithium battery to inhibit decomposition of the electrolyte, and thereby the rate of increase of the battery thickness when it is allowed to stand at a high temperature is significantly decreased and capacity storage characteristics at high temperature are improved.

### TECHNICAL FIELD

The present invention relates to a nonaqueous electrolyte for a battery, and more particularly to a novel nonaqueous electrolyte for a battery in which a furanone based derivative is added to a conventional nonaqueous electrolyte for a lithium battery to inhibit decomposition of the electrolyte and thereby the rate of increase of the battery thickness when it is allowed to stand at a high temperature is significantly decreased and capacity storage characteristics at high temperature are improved.

### BACKGROUND ART

A secondary lithium battery having a small and slim size which is used in a notebook computer, a camcorder, a mobile phone, and the like is composed of an cathode made of mixed oxides of lithium from which lithium ions can be released and inserted, a anode made of carbon material or lithium, and an electrolyte in which a suitable amount of a lithium salt is dissolved in a mixed organic solvent. This lithium battery is generally used in the form of a coin-, 18650 cylinder-, or a 063048 square-type battery. The lithium battery has an average discharge voltage of about 3.6 to 3.7 V and thus provides an advantage of obtaining relatively high power as compared to other alkaline batteries or a Ni-MH or Ni—Cd batteries.

In order to provide such a high drive voltage, there is a need for an electrolyte composition which is electrochemically stable in a charging/discharging area of 0 to 4.2 V, and thus in order to increase imbibition between a carbonate based organic solvent such as ethylene carbonate (EC), dimethyl carbonate (DMC), diethyl carbonate (DEC) and a separator, fluorobenzene (FB) is appropriately added thereto and used as an electrolyte solvent. As the solute for the electrolyte, lithium salts such as LiPF₆, LiBF₄, LiClO₄ and LiN(C₂F₅SO₃)₂ are typically used and they serve as a source of lithium ions in the battery thus enabling its basic operation. However, the nonaqueous electrolyte thus prepared has markedly lower ionic conductivity as compared to an aqueous electrolyte used in a Ni-MH or Ni—Cd battery, and therefore may present a disadvantage with regard to a high efficiency charging/discharging, and the like.

Lithium ions from a lithium metal complex oxide used as an cathode in initial charging of the lithium battery migrate to a graphite (crystalline or amorphous) electrode used as a anode and are intercalated between layers of the graphite electrode. At this time, since lithium ions are highly reactive, the electrolyte reacts with carbon atoms constituting the anode to form compounds such as Li₂CO₃, Li₂O and LiOH at the surface of the graphite anode. These compounds form a passivation layer at the surface of the graphite cathode, called an SEI (Solid Electrolyte Interface) film. Once the SEI film is formed, it plays a role as an ion tunnel to pass only lithium ions. The SEI film solvates lithium ions through such an ion tunnel effect and thereby organic solvent molecules having a large molecular weight moving along with lithium ions in the electrolyte, such as EC, DMC and DEC, are prevented from inserting into the graphite cathode thus disrupting the structure thereof. Once the SEI film is formed, lithium ions cannot undergo side reaction with the graphite cathode or other materials and the quantity of electric charge consumed to form the SEI film is discharged as non-reversible capacity which has a characteristic that it is not reversibly reactive. Therefore, further decomposition of the electrolyte does not occur and the amount of lithium ions in the electrolyte is reversibly maintained with maintenance of stable charging/discharging (See J. Power Sources (1994) 51: 79-104).

### DISCLOSURE OF INVENTION

### Technical Problem

Meanwhile, a thin square-type battery has a problem suffering from swelling of the battery thickness upon charging thereof, due to production of gas such as CO, CO₂, CH₄ and C₂H₆ resulting from decomposition of the carbonate based organic solvent during formation of the SEI (See J. Power Sources (1998) 72: 66-70). Further, when it is stored at a high temperature in a fully charged state (for example, left at a temperature of 85° C. for 4 hours after full charging up to 4.2 V), the SEQ film is gradually disintegrated by increased electrochemical and thermal energy as time lapses, and thereby the side reaction between the exposed surface of the cathode and the surrounding electrolyte occurs continuously. Then, continuous production of gas causes elevated internal pressure inside the battery and as a result, in case of the square-type battery and PLI (polymer lithium ion) battery, the thickness thereof increases thus resulting in difficulty of a set mounting.

### Technical Solution

The present invention to provide a novel nonaqueous electrolyte for a lithium battery in which a furanone based derivative is added to a conventional nonaqueous electrolyte for a lithium battery to inhibit decomposition of the electrolyte and thereby the rate of increase of the battery thickness when allowed to stand at a high temperature is significantly decreased and capacity storage characteristics at high temperature are improved.

In accordance with one aspect of the present invention, the above and other objects can be accomplished by the provision of a nonaqueous electrolyte for a battery containing 0.8 to 2 M of lithium salt dissolved therein, wherein 0.01 to 20% by weight of tetronic acid having the following formula (I) is added:

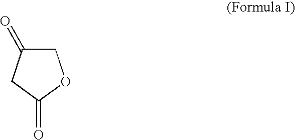

### ADVANTAGEOUS EFFECTS

Present invention to provide a novel nonaqueous electrolyte for a lithium battery in which a furanone based derivative is added to a conventional nonaqueous electrolyte for a lithium battery to inhibit decomposition of the electrolyte and thereby the rate of increase of the battery thickness when allowed to stand at a high temperature is significantly decreased and capacity storage characteristics at high temperature are improved.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a graph showing charging/discharging characteristics of a lithium battery prepared in an example in accordance with the present invention; and

FIG. 2 is a graph showing electrochemical characteristics of an nonaqueous electrolyte prepared in an example in accordance with the present invention.

### BEST MODE FOR CARRYING OUT THE INVENTION

Now, the present invention will be described in more detail.

As organic solvents used in preparing a nonaqueous electrolyte for a lithium battery in accordance with the present invention, mention may be made of cyclic carbonate based organic solvents such as ethylene carbonate (EC) and propylene carbonate (PC), and linear carbonate based organic solvents such as dimethyl carbonate (DMC), diethyl carbonate (DEC), ethylmethyl carbonate (EMC), methylpropyl carbonate (MPC) and ethylpropyl carbonate (EPC). Preferably, a mixture of at least one cyclic carbonate based organic solvent and at least one linear carbonate based organic solvent may be used, and more preferably a mixture of ethylene carbonate, ethylmethyl carbonate and diethyl carbonate may be used in a ratio of 1:1:1. In addition, solvents such as propyl acetate, methyl acetate, ethyl acetate, butyl acetate, methyl propionate, ethyl propionate and fluorobenzene may be additionally mixed and used, if desired. The mixing ratio of the respective organic solvents is not particularly limited as long as it does not interfere with the purpose of the present invention, and follows the mixing ratio used in preparing a conventional nonaqueous electrolyte for a lithium battery.

As examples of lithium salts contained in the nonaqueous electrolyte in accordance with the present invention, mention may be made of LiPF₆, LiClO₄, LiAsF₆, LiBF₄, LiN(C₂F₅SO₃)₂, and the like, and they may be used alone or as a mixture of two or more. More preferably, LiPF₆ may be used. The concentration of the lithium salt ranges from 0.8 to 2.0 M. Where the concentration of the lithium salt added is below 0.8 M, ionic conductivity may be lowered. Where it exceeds 2.0 M, the viscosity of the electrolyte increases and thus ionic conductivity may be lowered.

The nonaqueous electrolyte in accordance with the present invention is characterized in that 0.01 to 20.0% by weight, and preferably 0.1 to 10% by weight of tetronic acid, which is a furanone based derivative having the following formula (I), is added thereto. Where the above-mentioned content is less than 0.01% by weight, it is difficult to decrease the rate of increase of the battery thickness when it is allowed to stand at a high temperature, by inhibiting decomposition of the electrolyte. In addition, if the above-mentioned content exceeds 20% by weight, performances of the battery such as service life may be lowered.

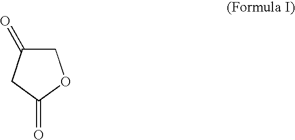

The nonaqueous electrolyte for a lithium battery in accordance with the present invention can be used to prepare the lithium battery by a conventional method. Even when the lithium battery thus prepared is allowed to stand at a high temperature (80° C., 10 days), production of gas inside the battery due to disintegration of the electrolyte is inhibited and thus swelling of the battery thickness is prevented and capacity storage characteristics at a high temperature become excellent.

### MODE FOR THE INVENTION

Now, the present invention will be described in more detail with reference to the following Examples. These examples are provided only for illustrating the present invention and should not be construed as limiting the scope and sprit of the present invention.

### Examples and Comparative Example

Ethylene carbonate (EC), ethylmethyl carbonate (EMC) and diethyl carbonate (DEC) were mixed in a ratio of 1:1:1 (v/v) and 1M of LiPF₆ as solute was dissolved therein to obtain a basic electrolyte. To the basic electrolyte thus obtained was added tetronic acid in the amount prescribed in Table 1 below to prepare an electrolyte of the present invention (Examples 1 to 5).

A lithium battery was prepared in the form of a square type 423048 battery. Graphite was used as the active material of the anode and PVDF was used as a binding agent. LiCoO₂ was used as the active material of the cathode and PVDF was used as the binding agent. As the conductive agent, acetylene black was used.

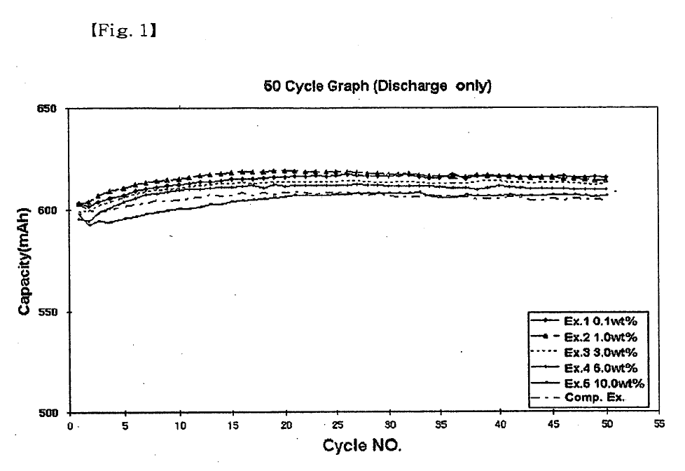

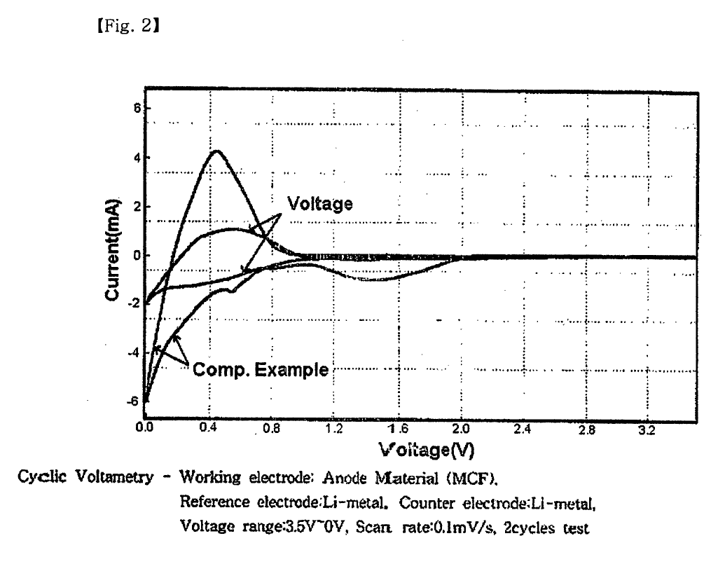

The prepared lithium battery was tested for swelling thereof at a high temperature (80° C., 10 days) under a fully charged state of 4.2 V after formation charging/discharging and standard charging/discharging procedures and the results are shown in Table 1. Meanwhile, a service life (standard charging/discharging) characteristic (50 cycles) was determined and shown in FIG. 1. Electrochemical characteristics were determined for the electrolytes (Example 2) to which 1.0% by weight of tetronic acid was added, respectively and the electrolyte to which no tetronic acid was added (Comparative Example) and are shown in FIG. 2.

TABLE 1

| | Tetronic | | | | | | |
|---|---|---|---|---|---|---|---|
| | acid | Formation | Formation | Formation | ΔIR | | |
| | added | charging | discharging | efficiency | (mΩ) | ΔV (volt) | ΔT (mm) |
| Ex. 1 | 0.1 wt % | 642.4 | 587.5 | 91.5 | 37.9 | −0.04 | 0.2 |
| Ex. 2 | 1.0 wt % | 648.3 | 591.2 | 91.2 | 38.0 | −0.03 | 0.2 |
| Ex. 3 | 3.0 wt % | 648.3 | 588.4 | 91.1 | 38.6 | −0.03 | 0.1 |
| Ex. 4 | 5.0 wt % | 643.0 | 586.6 | 91.2 | 39.9 | −0.03 | 0.1 |
| Ex. 5 | 10.0 wt % | 639.8 | 579.2 | 90.5 | 42.1 | −0.02 | 0.1 |
| Comp | — | 658.9 | 600.3 | 91.1 | 30.5 | −0.06 | 1.3 |
| Ex. | | | | | | | |

ΔIR (mΩ): Changes in internal resistance of the battery before and after being left at a high temperature
ΔV (volt): Changes in voltage of the battery before and after being left at a high temperature
ΔT (mm): Changes in thickness of the battery before and after being left at a high temperature
(High temperature conditions: 80° C. ± 2° C., 10 days)

### INDUSTRIAL APPLICABILITY

In accordance with the present invention, provided is a novel nonaqueous electrolyte for a lithium battery in which the rate of increase of the battery thickness even when it is allowed to stand at a high temperature is significantly decreased and capacity storage characteristics at high temperature are improved.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A nonaqueous electrolyte for a battery containing comprising 0.8 to 2 M of lithium salt dissolved therein, wherein said electrolyte further comprises 0.01 to 20% by weight of tetronic acid having the following formula (I)

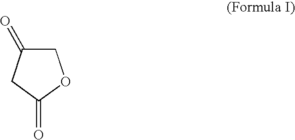

2. The nonaqueous electrolyte as set forth in claim 1, wherein the lithium salt comprises at least one material selected from the group consisting of LiPF₆, LiClO₄, LiAsF₆, LiBF₄ and LiN(C₂F₅SO₃)₂.

3. The nonaqueous electrolyte as set forth in claim 1, further comprising a solvent comprising a mixture of at least one cyclic carbonate based solvent and at least one linear carbonate based solvent.

4. A secondary lithium battery comprising a nonaqueous electrolyte as set forth in claim 1.
